(19) United States
(12) Patent Application Publication
(10) Pub. No.: US 2023/0276528 A1
(43) Pub. Date: Aug. 31, 2023

(54) METHOD AND APPARATUS FOR CONTROLLING TRANSMISSION OF SOUNDING REFERENCE SIGNAL (SRS) AND REPORTING OF CHANNEL STATE INFORMATION (CSI)

(71) Applicant: Samsung Electronics Co., Ltd., Gyeonggi-do (KR)

(72) Inventors: Vinay Kumar SHRIVASTAVA, Bangalore (IN); Sriganesh RAJENDRAN, Bangalore (IN); Sangkyu BAEK, Gyeonggi-do (KR)

(21) Appl. No.: 18/114,732

(22) Filed: Feb. 27, 2023

(30) Foreign Application Priority Data
Feb. 26, 2022 (IN) 202241010448
Feb. 10, 2023 (IN) 202241010448

(51) Int. Cl. H04W 76/28; H04W 4/06; H04B 7/06; H04L 5/00

(52) U.S. Cl. CPC H04W 76/28; H04W 4/06; H04B 7/0626; H04L 5/0051

(57) ABSTRACT

The disclosure relates to a 5G or 6G communication system for supporting a higher data transmission rate. Disclosed is a method by a user equipment (UE) for controlling at least one of transmitting a sounding reference signal (SRS) and reporting a channel state information (CSI), including receiving, from a base station, configuration information indicating whether a transmission of CSI or an SRS during a multicast and broadcast service (MBS) multicast discontinuous reception (DRX) active time is allowed, and determining whether to transmit the CSI or the SRS within the MBS multicast DRX active time and outside a unicast DRX active time, based on the configuration information, wherein, in case that the transmission of the CSI or the SRS during the MBS multicast DRX active time is allowed based on the configuration information, the CSI or the SRS is transmitted within the MBS multicast DRX active time and outside the unicast DRX active time.

### CROSS-REFERENCE TO RELATED APPLICATION(S)

This application is based on and claims priority under 35 U.S.C. § 119 to Indian Provisional Patent Application No. 202241010448 and Indian Complete Patent Application No. 202241010448, which were filed in the Indian Patent Office on Feb. 26, 2022 and Feb. 10, 2023, respectively, the entire disclosure of each of which is incorporated herein by reference.

### BACKGROUND

### 1. Field

The disclosure relates generally to a wireless communication system, and more particularly, to a method and user equipment for controlling transmission of sounding reference signal (SRS) and channel state information (CSI) reporting in a wireless communication system.

### 2. Description of Related Art

5G mobile communication technologies define broad frequency bands such that high transmission rates and new services are possible and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of fourth generation (4G) communication systems, efforts have been made to develop improved 5G or pre-5G communication systems, also referred to as “beyond 4G networks” or “post-LTE systems”.

In wireless communication systems, a new radio multicast broadcast service (NR MBS) is a multicast service where intended common contents are targeted to a group of UEs that have joined a multicast group in a multicast coverage area.

For the purpose of power saving and efficient scheduling, MBS multicast reception is associated with a session specific discontinuous reception (DRX) approach. DRX operation is defined with certain DRX timers which define a procedure to control the DRX operation for a specific MBS session reception. However, when the UE is configured with a multicast DRX and a unicast DRX, various functionalities and procedures of the UE will be impacted as a DRX active time and/or DRX ON duration of the multicast DRX and the unicast DRX may not overlap/coincide.

In conventional systems and methods, certain procedures such as CSI reporting and SRS transmission are performed during the DRX active time and/or the DRX ON duration of the unicast DRX; however, the conventional system and methods does not consider the multicast DRX which is configured independently of the unicast DRX.

The conventional methods and systems disclose a downlink control information cyclic redundancy check for power saving (DCP)/wake-up signal (WUS) which is operated for the unicast DRX in an RRC_CONNECTED state; however, the conventional systems fail to disclose anything related to the multicast DRX that has a different active time and/or DRX ON duration than the unicast DRX and its impact on the DCP/WUS based CSI reporting and/or SRS transmission.

Thus, there is a need in the art to provide a useful alternative to efficiently perform CSI reporting and/or SRS transmission operation along with the unicast DRX and the multicast DRX for the UE.

### SUMMARY

The disclosure has been made to address at least the above-mentioned problems and/or disadvantages and to provide at least the advantages described below.

Accordingly, an aspect of the disclosure is to provide a method and a UE for controlling at least one of transmitting an SRS and reporting a CSI to effectively perform CSI reporting and/or SRS transmission operation along with unicast and multicast DRX for the UE.

An aspect of the disclosure is to receive an allowCSI-SRS-Tx-MulticastDRX-Active parameter in an RRC reconfiguration message from a network node, wherein the allowCSI-SRS-Tx-MulticastDRX-Active parameter is a configuration parameter and determines whether the configured allowCSI-SRS-Tx-MulticastDRX-Active parameter allows the UE to transmit the SRS and report the CSI during an multicast DRX which addresses the issues of DRX operations for MBS multicast and increases the effective scheduling and channel estimation by a network.

An aspect of the disclosure is to meet a new requirement for the DRX approach for MBS in order to support efficient and reliable power delivery of 5G MBS services for multiple groups of NMBS services, each being identified by a group radio network temporary identifiers (G-RNTIs). Thus, multiple G-RNTIs are configured for the UE and each G-RNTI has its own MBS multicast DRX configuration and/or operation including a hybrid automatic repeat request (HARQ).

In accordance with an aspect of the disclosure, a method for controlling at least one of transmitting an SRS and reporting a CSI by a UE, includes receiving, from a base station, configuration information indicating whether a transmission of CSI or an SRS during a multicast and broadcast service (MBS) multicast discontinuous reception (DRX) active time is allowed, and determining whether to transmit the CSI or the SRS within the MBS multicast DRX active time and outside a unicast DRX active time, based on the configuration information, wherein, in case that the transmission of the CSI or the SRS during the MBS multicast DRX active time is allowed based on the configuration information, the CSI or the SRS is transmitted within the MBS multicast DRX active time and outside the unicast DRX active time.

In accordance with an aspect of the disclosure, a method performed by a base station in wireless communication includes transmitting, to a UE, configuration information indicating whether a transmission of CSI or an SRS during an MBS DRX active time is allowed, and receiving, from the UE, the CSI or the SRS within the MBS multicast DRX active time and outside the unicast DRX active time, in case that the transmission of the CSI or the SRS during the MBS multicast DRX active time is allowed based on the configuration information.

In accordance with an aspect of the disclosure, a UE in a wireless communication includes a transceiver, and at least one processor operatively coupled with the transceiver and configured to receive, from a base station, configuration information indicating whether a transmission of CSI or an SRS during an MBS DRX active time is allowed, and determine whether to transmit the CSI or the SRS within the MBS multicast DRX active time and outside a unicast DRX active time, based on the configuration information, wherein, in case that the transmission of the CSI or the SRS during the MBS multicast DRX active time is allowed based on the configuration information, the CSI or the SRS is transmitted within the MBS multicast DRX active time and outside the unicast DRX active time.

In accordance with an aspect of the disclosure, a base station in a wireless communication includes a transceiver, and at least one processor operatively coupled with the transceiver and configured to transmit, to a UE, configuration information indicating whether a transmission of CSI or an SRS during an MBS DRX active time is allowed; and receive, from the UE, the CSI or the SRS within the MBS multicast DRX active time and outside the unicast DRX active time, in case that the transmission of the CSI or the SRS during the MBS multicast DRX active time is allowed based on the configuration information.

### BRIEF DESCRIPTION OF THE DRAWINGS

The above and other aspects, features, and advantages of certain embodiments will be more apparent from the following description taken in conjunction with the accompanying drawings, in which:

FIG. 1 is a block diagram illustrating a UE for controlling at least one of transmitting SRS and reporting a CSI, according to an embodiment;

FIG. 2 illustrates a method for controlling at least one of transmitting the SRS and reporting the CSI, according to an embodiment;

FIG. 3 illustrates a configuration for the CSI reporting and/or the SRS transmission during multicast DRX Active time and unicast DRX non-Active time, according to an embodiment;

FIG. 4 illustrates a process of controlling the transmission of SRS and reporting of CSI based on the allowCSI-SRS-Tx-MulticastDRX-Active parameter, according to an embodiment;

FIG. 5 illustrates a process of controlling the transmission of SRS and reporting of CSI when the UE is configured with CSI masking, according to an embodiment;

FIG. 6 illustrates various signaling options for controlling the transmission of SRS and reporting of CSI, according to an embodiment;

FIG. 7 illustrates a process of controlling the transmission of SRS and reporting of CSI when the UE is configured with a downlink control information cyclic redundancy check power-saving radio network temporary identifier (DCP) monitoring, according to an embodiment;

FIG. 8 illustrates a process of controlling the transmission of SRS and reporting of CSI when the UE is not configured with the DCI monitoring, according to an embodiment;

FIG. 9 illustrates the DCP/Wake-up Signal (WUS) configuration release and setup along with the multicast DRX configuration and release, according to an embodiment;

FIG. 10 illustrates a procedure for DCP/WUS configuration deactivation and activation along with the multicast DRX configuration and release, according to an embodiment;

FIG. 11 illustrates a procedure for the UE based DCP/WUS configuration local suspension and local resumption along with the multicast DRX configuration and release, according to an embodiment;

FIG. 12 is a block diagram of a structure of a UE according to an embodiment; and

FIG. 13 is a block diagram of a structure of a base station (BS) according to an embodiment.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely examples. Accordingly, those of ordinary skill in the art will recognize that various changes and modifications of the various an embodiment can be made without departing from the scope and spirit of the disclosure. In addition, descriptions of well-known functions and constructions may be omitted for the sake of clarity and conciseness.

The terms and words used in the following description and claims are not limited to their dictionary meanings, but are merely used to enable a clear and consistent understanding of the disclosure. Accordingly, it should be apparent to those skilled in the art that the following description of various embodiments of the disclosure is provided for illustration purposes only and not for the purpose of limiting the disclosure.

It is to be understood that the singular forms “a,” “an,” and “the” include plural referents unless the context clearly dictates otherwise. Thus, for example, reference to “a component surface” includes reference to one or more of such surfaces.

Before undertaking the detailed description below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, indicate inclusion without limitation. The term “or” is inclusive, meaning and/or. The phrase “associated with,” as well as derivatives thereof, indicates to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, indicates that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as read-only memory (ROM), random access memory (RAM), a hard disk drive, a compact disc (CD), a digital video disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure pertains.

It should be understood that “first”, “second” and similar words used in the disclosure do not express any order, quantity or importance, but are only used to distinguish different components.

As used herein, any reference to “an example” or “example”, “an implementation” or “implementation”, “an embodiment” or “embodiment” indicates that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something indicates “at least some of” the thing, and as such may mean less than all of, or all of, the thing. As such, “a portion of” a thing includes the entire thing as a special case, i.e., the entire thing is an example of a portion of the thing.

As used herein, the term “set” indicates one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

Those skilled in the art will understand that the principles of the disclosure can be implemented in any suitably arranged wireless communication system. For example, although the following detailed description of the embodiments of the disclosure will be directed to long term evolution (LTE) and/or fifth generation (5G) communication systems, those skilled in the art will understand that the main aspects of the disclosure can also be applied to other communication systems with similar technical backgrounds and channel formats with slight modifications without departing from the scope of the disclosure. The technical schemes of the embodiments of the application can be applied to various communication systems, and for example, the communication systems may include global systems for mobile communications (GSM), code division multiple access (CDMA) systems, wideband code division multiple access (WCDMA) systems, general packet radio service (GPRS) systems, LTE systems, LTE frequency division duplex (FDD) systems, LTE time division duplex (TDD) systems, universal mobile telecommunications system (UMTS), worldwide interoperability for microwave access (WiMAX) communication systems, 5G systems or NR systems, etc. In addition, the technical schemes of the embodiments of the application can be applied to future-oriented communication technologies.

The embodiments herein and the various features related to unicast discontinuous reception (DRX) and/or multicast DRX that may or may not be configured, and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of manners in which the embodiments herein can be practiced and to further enable those skilled in the art to practice the embodiments herein. Accordingly, the examples should not be construed as limiting the scope of the embodiments herein.

The accompanying drawings are used to assist in the understanding of various technical features and it should be understood that the embodiments presented herein are not limited by the accompanying drawings. As such, the disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The various actions, acts, blocks, steps, or the like in the methods disclosed herein may be performed in the order presented, in a different order or simultaneously. Some of the actions, acts, blocks, steps, or the like may be omitted, added, modified, skipped, or the like without departing from the scope of the disclosure.

Accordingly, the embodiments herein disclose a method for controlling at least one of transmitting a Sounding Reference Signal (SRS) and reporting a Channel State Information (CSI) by a User Equipment (UE). The method includes receiving, by the UE, an allowCSI-SRS-Tx-MulticastDRX-Active parameter in an RRC reconfiguration message from a network node, wherein the allowCSI-SRS-Tx-MulticastDRX-Active parameter is a configuration parameter. The method further includes configuring the UE with at least one of the allowCSI-SRS-Tx MulticastDRX-Active parameter, a CSI masking, and a Downlink control information Cyclic redundancy check Power-saving radio network temporary identifier (DCP) monitoring; determining, by the UE, whether the UE is configured with the allowCSI-SRS-Tx-MulticastDRX-Active parameter. The method further includes determining, by the UE, whether the configured allowCSI-SRS-Tx-MulticastDRX-Active parameter allows the UE to transmit the SRS and report the CSI during a multicast DRX when the UE is configured with the allowCSI-SRS-Tx-MulticastDRX-Active parameter. The method further includes determining, by the UE, a time for transmitting the SRS and reporting the CSI during the multicast service reception based on the allowCSI-SRS-Tx-MulticastDRX-Active parameter when the allowCSI-SRS-Tx-MulticastDRX-Active parameter allows the UE to transmit the SRS and report the CSI during the multicast DRX. The method further includes transmitting, by the UE, the SRS and reporting the CSI in the determined time based on an Active Time of the at least one of a unicast DRX and the multicast DRX.

Accordingly, the embodiments herein disclose a UE for controlling at least one of transmitting the SRS and reporting the CSI comprises: a memory; a processor coupled to the memory; a SRS/CSI controller coupled to the memory and the processor. The SRS/CSI controller is configured to receive the allowCSI-SRS-Tx-MulticastDRX-Active parameter in the RRC reconfiguration message from the network node, wherein the allowCSI-SRS-Tx-MulticastDRX-Active parameter is the configuration parameter. The SRS/CSI controller is further configured to configure the UE with at least one of the allowCSI-SRS-Tx-MulticastDRX-Active parameter, the CSI masking, and the DCP monitoring; determining whether the UE is configured with the allowCSI-SRS-Tx-MulticastDRX-Active parameter. The SRS/CSI controller is further configured to determine whether the configured allowCSI-SRS-Tx-MulticastDRX-Active parameter allows the UE to transmit the SRS and report the CSI during the multicast DRX when the UE is configured with the allowCSI-SRS-Tx-MulticastDRX-Active parameter. The SRS/CSI controller is further configured to determine the time for transmitting the SRS and reporting the CSI during the multicast service reception based on the allowCSI-SRS-Tx-MulticastDRX-Active parameter when the allowCSI-SRS-Tx-MulticastDRX-Active parameter allows the UE to transmit the SRS and report the CSI during the multicast DRX. The SRS/CSI controller is further configured to transmit the SRS and reporting the CSI in the determined time based on the Active Time of the at least one of the unicast DRX and the multicast DRX.

In wireless communication systems, a New Radio multicast broadcast service (NR MBS) refers to multicast services where intended common contents are targeted to a group of UEs that have joined a multicast group in a multicast coverage area. The NR MBS service refers to broadcast services where intended contents are targeted to all the UEs in a broadcast coverage area and the broadcast services coverage area can be one cell or larger.

Two delivery methods envisioned for 5G MBS service, from the view point of 5G core network (CN) are the individual MBS traffic delivery method and the shared MBS traffic delivery method. For the individual MBS traffic delivery method, the CN receives a single copy of MBS data packets and delivers separate copies of those MBS data packets to individual UEs via per-UE PDU sessions, while for the shared MBS traffic delivery method, 5G CN receives a single copy of MBS data packets and delivers a single copy of those MBS packets packet to a radio access node (RAN), which then delivers them to one or multiple UEs. RAN delivers MBS data to the UEs using either a point-to-point delivery (PTP) or a point-to-multipoint (PTM) delivery. PTP is data transmission to a single target UE in the MBS. PTM is data transmission to the multiple target UEs in the MBS. At the UE, an MBS bearer can be composed of a common protocol data convergence protocol (PDCP) entity with PTP, PTM or a combination of PTP and PTM legs or RLC entities (also referred to as an MBS split bearer).

Generally, for the purpose of power saving and efficient scheduling, MBS multicast reception is associated with a session specific discontinuous reception (DRX) approach. DRX operation is defined with certain DRX timers which define the procedure to control the DRX operation for a specific MBS session reception. However, when the UE is configured with the multicast DRX and unicast DRX, various functionalities and procedures will be impacted as the DRX active time and/or DRX ON duration of the multicast DRX and unicast DRX may not overlap/coincide.

As previously noted, in conventional systems and methods, certain procedures such as channel state information (CSI) reporting, sounding reference signal (SRS) transmission are performed during the DRX active time and/or DRX ON duration of the unicast DRX; however, the conventional system and methods do not consider the multicast DRX which is configured independently of the unicast DRX, and do not teach a multicast DRX that has different active time and/or DRX ON duration than the unicast DRX, and its impacts on DCP/WUS based CSI reporting and/or SRS transmission.

Thus, to the present disclosure provides a solution to effectively and efficiently perform CSI reporting and/or SRS transmission operation along with unicast DRX and multicast DRX for the UE.

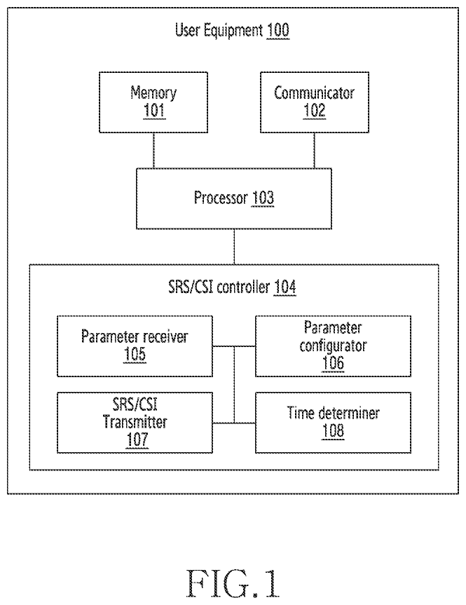

FIG. 1 is a block diagram illustrating a UE (100) for controlling at least one of transmitting a SRS and reporting a CSI, according to an embodiment.

Referring to FIG. 1, examples of the UE (100) include but are not limited to a laptop, a palmtop, a desktop, a mobile phone, a smartphone, personal digital assistant (PDA), a tablet, a wearable device, an IoT device, a virtual reality device, a foldable device, a flexible device, a connected car, an autonomous vehicle, a television, and an immersive system.

The UE (100) includes a memory (101), a processor (103), a communicator (102) and an SRS/CSI controller (104).

The memory (101) stores instructions for controlling the transmission of SRS and reporting of a CSI which is to be executed by the processor (103). The memory (101) may include non-volatile storage elements. Examples of such non-volatile storage elements may include magnetic hard discs, optical discs, floppy discs, flash memories, or forms of an electrically programmable memory (EPROM) or electrically erasable and programmable memory (EEPROM). In addition, the memory (101) may be considered as a non-transitory storage medium. The term “non-transitory” may indicate that the storage medium is not embodied in a carrier wave or a propagated signal. However, the term “non-transitory” should not be interpreted as the memory (101) being stationary. In some examples, the memory (101) can be configured to store larger amounts of information than its storage space. In certain examples, a non-transitory storage medium may store data that can, over time, change (e.g., in a random access memory (101) (RAM) or cache). The memory (101) can be an internal storage unit or an external storage unit of the alarm monitoring device (200), a cloud storage, or any other type of external storage.

The processor (103) is configured to execute instructions stored in the memory (101). The processor (103) may be a general-purpose processor (103), such as a central processing unit (CPU), an application processor (AP), or the like, a graphics-only processing unit such as a graphics processing unit (GPU), a visual processing unit (VPU) and the like. The processor (103) may include multiple cores to execute the instructions.

The communicator (102) is configured for communicating internally between hardware components in the UE (100), and is configured to facilitate the communication between the UE (100) and other devices via one or more networks, such as by radio technology. The communicator (102) includes an electronic circuit specific to a standard that enables wired or wireless communication.

The processor (103) is coupled with the SRS/CSI controller (104) to perform the requested task. The SRS/CSI controller (104) includes a parameter receiver (105), a parameter configurator (106), an SRS/CSI transmitter (107) and a time determiner (108).

The parameter receiver (105) receives an allowCSI-SRS-Tx-MulticastDRX-Active parameter in an RRC reconfiguration message from a network node, wherein the allowCSI-SRS-Tx-MulticastDRX-Active parameter is a configuration parameter.

The parameter configurator (106) configures the UE (100) with at least one of the allowCSI-SRS-Tx-MulticastDRX-Active parameter, a CSI masking, and a DCP monitoring and determines whether the UE (100) is configured with the allowCSI-SRS-Tx-MulticastDRX-Active parameter. The parameter configurator (106) determines whether the configured allowCSI-SRS-Tx-MulticastDRX-Active parameter allows the UE (100) to transmit the SRS and report the CSI during a multicast DRX when the UE (100) is configured with the allowCSI-SRS-Tx-MulticastDRX-Active parameter.

The time determiner (108) determines a time (or a time duration) for transmitting the SRS and reporting the CSI during the multicast service reception based on the allowCSI-SRS-Tx-MulticastDRX-Active parameter when the allowCSI-SRS-Tx-MulticastDRX-Active parameter allows the UE (100) to transmit the SRS and report the CSI during the multicast DRX.

The SRS/CSI transmitter (107) transmits the SRS and reports the CSI in the determined time based on an active time of the at least one of a unicast DRX and the multicast DRX.

The SRS/CSI controller (104) determines whether the UE (100) is configured with the CSI masking and whether a DRX on-duration timer of the unicast DRX is running when the UE (100) is configured with the CSI masking. The SRS/CSI controller (104) reports the CSI on the PUCCH when the DRX on-duration timer of the unicast DRX is running. The SRS/CSI controller (104) determines whether the DRX on-duration timer of at least one multicast DRX is running when the DRX on-duration timer of the unicast DRX is not running, and reports the CSI on the PUCCH when the DRX on-duration timer of the at least one multicast DRX is running.

The SRS/CSI controller (104) determines whether the DRX on-duration timer of at least one multicast DRX is running considering at least one of a multicast assignment, a DRX command MAC control element and a long DRX command MAC control element until a threshold time prior to the current symbol. The SRS/CSI controller (104) skips reporting of the CSI on the PUCCH when the DRX on-duration timers of the all multicast DRXs corresponding to the DRX group are not running, or determines whether the allowCSI-SRS-Tx-MulticastDRX-Active parameter is configured for transmitting SRS and reporting CSI during the multicast DRX when the DRX on-duration timer of the at least one multicast DRX is running. The SRS/CSI controller (104) skips reporting of the CSI on the PUCCH when the allowCSI-SRS-Tx-MulticastDRX-Active parameter is not configured for transmitting SRS and reporting CSI during the multicast DRX; or reports the CSI on the PUCCH when the allowCSI-SRS-Tx-MulticastDRX-Active parameter is configured for transmitting SRS and reporting CSI during the multicast DRX.

The SRS/CSI controller (104) determines whether a MAC entity of the UE (100) is in the active time of the unicast DRX, and determines whether the MAC entity of the UE (100) is in the active time of the at least one multicast DRX when the MAC entity of the UE (100) is not in the active time (i.e., is outside of the active time) of the unicast DRX. The SRS/CSI controller (104) determines whether the UE (100) is configured with the allowCSI-SRS-Tx-MulticastDRX-Active parameter when the MAC entity of the UE (100) is in the active time of the at least one multicast DRX. The SRS/CSI controller (104) transmits the SRS and reporting the CSI in an active time of at least one multicast DRX when the UE (100) is configured with the allowCSI-SRS-Tx-MulticastDRX-Active parameter for transmitting SRS and reporting CSI during the multicast DRX.

The SRS/CSI controller (104) determines whether the MAC entity of the UE (100) is in the active time of the unicast DRX; and transmits the SRS and reporting the CSI when the MAC entity of the UE (100) is in the active time of the unicast DRX.

The SRS/CSI controller (104) skips transmission of the SRS and reporting of the CSI when the MAC entity of the UE (100) is not in the active time of any of the multicast DRXs, or determines whether the allowCSI-SRS-Tx-MulticastDRX-Active parameter is configured for transmitting SRS and reporting CSI during the multicast DRX when the MAC entity of the UE (100) is in the active time of at least one multicast DRX. The SRS/CSI controller (104) skips transmission of the SRS and reporting of the CSI when the allowCSI-SRS-Tx-MulticastDRX-Active parameter is not configured for transmitting SRS and reporting CSI during the multicast DRX or transmits the SRS and reports the CSI when the allowCSI-SRS-Tx-MulticastDRX-Active parameter is configured for transmitting SRS and reporting CSI during the multicast DRX.

The SRS/CSI controller (104) transmits the SRS including transmitting the at least one of periodic SRS and semi-persistent SRS.

The SRS/CSI controller (104) reports the CSI on a physical uplink control channel (PUCCH) and reports a semi-persistent CSI on a physical uplink shared channel (PUSCH).

The SRS/CSI controller (104) determines whether the UE (100) is configured with the DCP monitoring. The SRS/CSI controller (104) determines whether a current symbol occurs within the DRX on-duration timer duration of the unicast DRX; wherein the DRX on-duration is associated with a current DRX cycle that is not started. The SRS/CSI controller (104) determines whether the allowCSI-SRS-Tx-MulticastDRX-Active parameter is configured for transmitting SRS and reporting CSI during the multicast DRX. The SRS/CSI controller (104) performs one of configuring the UE (100) with the DCP monitoring or the current symbol occurs within the DRX on-duration timer duration of the unicast DRX. The DRX on-duration is associated with the current DRX cycle that is not started. The SRS/CSI controller (104) skips transmission of the SRS and reporting of the CSI when the allowCSI-SRS-Tx-MulticastDRX-Active parameter is not configured for transmitting the SRS and reporting CSI during the multicast DRX. The SRS/CSI controller (104) determines whether the MAC entity is in the active time of the at least one of the multicast DRX until a threshold time prior to the current symbol and the allowCSI-SRS-Tx-MulticastDRX-Active parameter is configured for transmitting the SRS and reporting CSI during the multicast DRX.

The SRS/CSI controller (104) determines whether the MAC entity is in the active time of the at least one of the multicast DRX until a threshold time prior to the current symbol. The SRS/CSI controller (104) skips transmission of the SRS and reporting of the CSI when none of the multicast DRXs is in active time, or transmits the SRS and reports the CSI to the network node when at least one the multicast DRXs is in active time.

The SRS/CSI controller (104) determines whether the UE (100) is configured with the allowCSI-SRS-Tx-MulticastDRX-Active parameter when the UE (100) is not configured with the DCP. The SRS/CSI controller (104) skips transmission of the least one of CSI, semi-persistent CSI, periodic SRS, and semi-persistent SRS to the network node when the UE (100) is not configured with the allowCSI-SRS-Tx-MulticastDRX-Active parameter. The SRS/CSI controller (104) determines the active time for all the multicast DRXs considering at least one of the multicast assignment, the DRX command MAC control element and the long DRX command MAC control element until the threshold time prior to the current symbol when the UE (100) is configured with the allowCSI-SRS-Tx-MulticastDRX-Active parameter.

The SRS/CSI controller (104) determines whether the at least one multicast DRX is in the active time considering at least one of a multicast assignment, a DRX command MAC control element and a long DRX command MAC control element until a threshold time prior to the current symbol. The SRS/CSI controller (104) skips transmission of the least one of CSI, semi-persistent CSI, periodic SRS, and semi-persistent SRS to the network node when all the multicast DRXs are not in the active time. The SRS/CSI controller (104) transmits the least one of CSI and SRS, to the network node when the MAC entity of the at least one multicast DRX is in the active time for at least one multicast DRX.

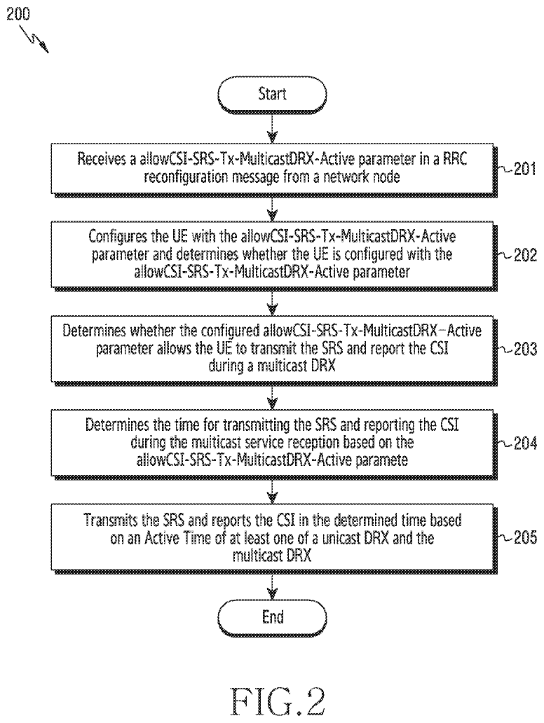

FIG. 2 is a flow chart (200) illustrating a method for controlling the transmitting of the SRS and reporting of the CSI, according to an embodiment.

In step 201, the UE (100) receives the allowCSI-SRS-Tx-MulticastDRX-Active parameter in the RRC reconfiguration message from the network node, wherein the allowCSI-SRS-Tx-MulticastDRX-Active parameter is the configuration parameter.

In step 202, the UE (100) configures the UE (100) with at least one of the allowCSI-SRS-Tx-MulticastDRX-Active parameter, the CSI masking, and the DCP monitoring; and determines whether the UE (100) is configured with the allowCSI-SRS-Tx-MulticastDRX-Active parameter.

In step 203, the UE (100) determines whether the configured allowCSI-SRS-Tx-MulticastDRX-Active parameter allows the UE (100) to transmit the SRS and report the CSI during the multicast DRX when the UE (100) is configured with the allowCSI-SRS-Tx-MulticastDRX-Active parameter.

In step 204, the UE (100) determines the time (or time duration) for transmitting the SRS and reporting the CSI during the multicast service reception based on the allowCSI-SRS-Tx-MulticastDRX-Active parameter when the allowCSI-SRS-Tx-MulticastDRX-Active parameter allows the UE (100) to transmit the SRS and report the CSI during the multicast DRX.

In step 205, the UE (100) transmits the SRS and reports the CSI in the determined time based on the active time of the at least one of the unicast DRX and the multicast DRX.

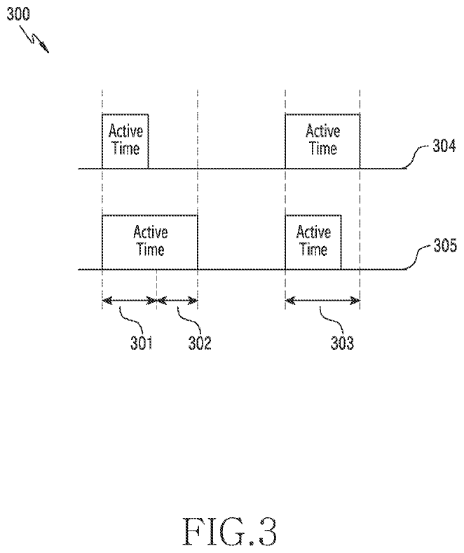

FIG. 3 is a schematic diagram (300) illustrating configuration for the CSI reporting and/or the SRS transmission during multicast DRX Active time and unicast DRX non-Active time, according to an embodiment.

FIG. 3 discloses the active time for the unicast DRX (304) and multicast DRX (305). During the time duration indicated by 301, CSI-RS reporting and SRS transmission is possible. During the time duration indicated by 302, UE determines whether the allowCSI-SRS-Tx-MulticastDRX-Active parameter is configured, and the CSI-RS reporting and SRS transmission are possible when the allowCSI-SRS-Tx-MulticastDRX-Active parameter is configured. The CSI-RS reporting and SRS transmission are not possible when the allowCSI-SRS-Tx-MulticastDRX-Active parameter is not configured. During the time duration indicated by 303, the CSI-RS reporting and the SRS transmission are possible.

As UE (100) power saving is one of the most important issues in mobile communications, the DRX can be configured for MBS multicast. Each multicast service can have a dedicated DRX configuration referred to as multicast DRX. The RRC controls multicast DRX operation for PTM per G-RNTI or per group-configured scheduling—radio network temporary identifier (G-CS-RNTI) by configuring the following parameters—

drx-onDurationTimerPTM: the duration at the beginning of a DRX cycle;

drx-SlotOffsetPTM: the delay before starting the drx-onDurationTimerPTM;

drx-InactivityTimerPTM: the duration after the PDCCH occasion in which a PDCCH indicates a new DL multicast transmission for the MAC entity;

drx-LongCycleStartOffsetPTM: the long DRX cycle and drx-StartOffsetPTM which defines the subframe where the long DRX cycle starts;

drx-RetransmissionTimerDL-PTM (per DL HARQ process for multicast MBS): the maximum duration until a DL multicast retransmission is received;

drx-HARQ-RTT-TimerDL-PTM (per DL HARQ process for multicast MBS): the minimum duration before a DL multicast assignment for HARQ retransmission is expected by the MAC entity.

The active time is the time period during which the MAC entity monitors a set of allocated RNTIs. Multicast DRX active time is the time period during which the MAC entity monitors a set of allocated group RNTIs, i.e., G-RNTI and G-CS-RNTI on a group-common PDCCH. When multicast DRX is configured for a G-RNTI or G-CS-RNTI, the active time includes the time while

drx-onDurationTimerPTM or drx-InactivityTimerPTM or drx-RetransmissionTimerDL-PTM for this G-RNTI or G-CS-RNTI is running. If a DRX command MAC CE indicated by PDCCH addressed to a G-RNTI or G-CS-RNTI, or by a configured downlink multicast assignment is received, then the MAC entity stops drx-onDurationTimerPTM of the DRX for this G-RNTI or G-CS-RNTI and stops drx-InactivityTimerPTM of the DRX for this G-RNTI or G-CS-RNTI.

Unicast DRX active time is the time period during which the MAC entity monitors a set of UE (100)-specific RNTIs, i.e. C-RNTI and CS-RNTI on UE (100)-specific PDCCH.

The time period which is not the active time is referred to as a non-active time, whereas the PTP DRX configuration is identical to the unicast DRX configuration.

When the UE (100) is configured with the multicast DRX and unicast DRX, various functionalities/procedures will be impacted as the on duration of the multicast DRX and unicast DRX will not overlap/coincide. In the current specification, certain procedures like CSI reporting, SRS transmission etc. are performed during DRX on duration or Active time of unicast DRX, but this does not take into account the multicast DRX which is configured independently of the unicast DRX. This invention describes how the various procedures are impacted and solutions to handle it when both unicast and multicast DRX are configured in the UE (100).

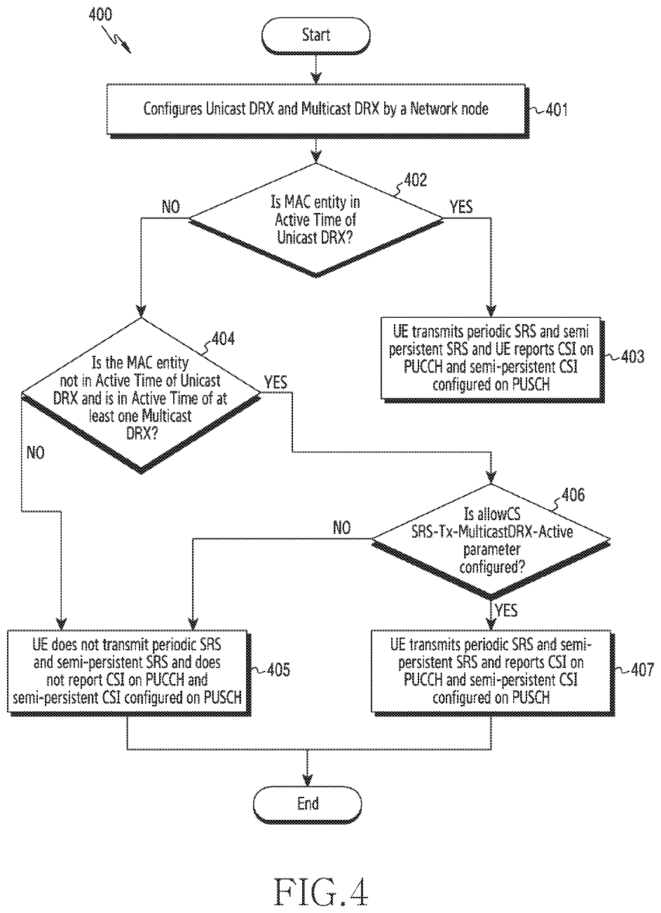

FIG. 4 is a flow chart (400) illustrating a process of controlling the transmission of SRS and reporting of CSI based on the allowCSI-SRS-Tx-MulticastDRX-Active parameter, according to an embodiment.

In step 401, the unicast DRX and the multicast DRX are configured by the network node.

In step 402, the UE (100) determines whether the MAC entity is in the active time of unicast DRX.

In step 403, the UE (100) transmits periodic SRS and semi persistent SRS and UE (100) reports CSI on the PUCCH and semi-persistent CSI configured on the PUSCH when the MAC entity is in the active time of unicast DRX.

In step 404, the UE (100) determines whether the MAC entity is not in the active time of the unicast DRX and the MAC entity is in the active time of at least one multicast DRX, when the MAC entity is not in the active time of unicast DRX.

In step 405, the UE (100) does not transmit periodic SRS and semi-persistent SRS and does not report CSI on the PUCCH and semi-persistent CSI configured on the PUSCH, when the MAC entity is in the active time of unicast DRX and any configured multicast DRX.

In step 406, the UE (100) determines whether the allowCSI-SRS-Tx-MulticastDRX-Active parameter is configured when the MAC entity is not in the active time of unicast DRX and the MAC entity is in the active time of at least one multicast DRX.

In step 407, UE (100) transmits periodic SRS and semi-persistent SRS at the configured timing and reports CSI on the PUCCH and semi-persistent CSI configured on the PUSCH when the allowCSI-SRS-Tx-MulticastDRX-Active parameter is configured.

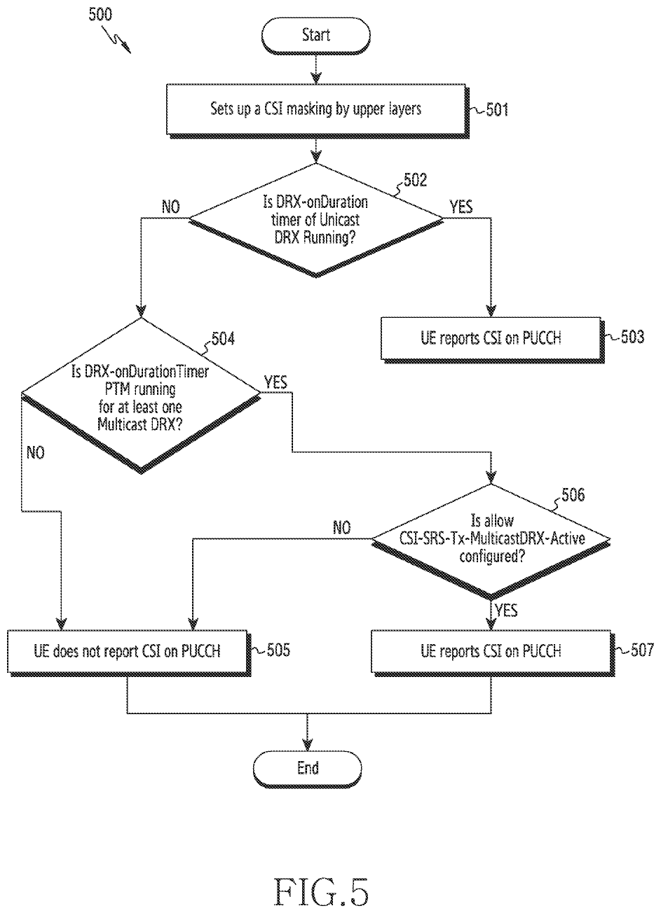

FIG. 5 is a flow chart (500) illustrating a process of controlling the transmission of SRS and reporting of CSI when the UE (100) is configured with CSI masking, according to an embodiment.

In step 501, the CSI masking is set up by upper layers.

In step 502, the UE (100) determines whether the DRX-onDuration timer of unicast DRX is running.

In step 503, the UE (100) reports CSI on PUCCH when the DRX-onDuration timer of unicast DRX is running.

In step 504, the UE (100) determines whether DRX-onDurationTimerPTM is running for at least one multicast DRX when the DRX-onDuration timer of unicast DRX is not running.

In step 505, the UE (100) does not report CSI on PUCCH when the DRX-onDurationTimerPTM is not running for at least one multicast DRX and when the allowCSI-SRS-Tx-MulticastDRX-Active parameter is not configured.

In step 506, the UE (100) determines whether the allowCSI-SRS-Tx-MulticastDRX-Active parameter is configured when the DRX-onDurationTimerPTM is running of any configured multicast DRX.

In step 507, the UE (100) reports CSI on PUCCH when the allowCSI-SRS-Tx-MulticastDRX-Active parameter is configured.

An alternative for the DRX method is provided below:

<Text Omitted>
1> if DCP monitoring is configured for the active DL BWPas specified in TS 38.213 [6], clause 10.3; and
1> if the current symbol n occurs within drx-onDurationTimer duration; and
1> if drx-onDurationTimer associated with the current DRX cycle is not started as specified in this clause:
2> if the MAC entity would not be in Active Time considering grants/assignments/DRX Command MAC CE/Long DRX Command MAC CE received and Scheduling Request sent until 4 ms prior to symbol n when evaluating all DRX Active Time conditions as specified in this clause; and
2> ______ if allowCSI-SRS-Tx-MulticastDRX-Active is not configured or, if all multicast DRXes of all multicast services would not be in Active Time considering multicast assignments and DRX Command MAC CE for MBS multicast received until 4 ms prior to symbol n when evaluating all DRX Active Time conditions as specified in Clause 5.7b:
3> not transmit periodic SRS and semi-persistent SRS defined in TS 38.214 [7];
3> not report semi-persistent CSIconfigured on PUSCH;
3> if ps-TransmitPeriodicLI-RSRP is not configured with value true:
4> not report periodic CSI that is L1-RSRP on PUCCH.
3> if ps-TransmitOtherPeriodicCSIis not configured with value true:
4> not report periodic CSI that is not L1-RSRP on PUCCH.
1> else:
2> in current symbol n, if a DRX group would not be in Active Time considering grants/assignments scheduled on Serving Cell(s) in this DRX group and DRX Command MAC CE/Long DRX Command MAC CE received and Scheduling Request sent until 4 ms prior to symbol n when evaluating all DRX Active Time conditions as specified in this clause; and
2> if allowCSI-SRS-Tx-MulticastDRX-Active is not configured, or in current symbol n, if multicast DRX of all configured multicast services would not be in Active Time considering multicast grants/assignments when evaluating all multicast DRX Active Time conditions as specified in clause 5.7b:
3> not transmit periodic SRS and semi-persistent SRS defined in TS 38.214 [7] in this DRX group;
3> not report CSI on PUCCH and semi-persistent CSI configured on PUSCH in this DRX group.
2> if CSI masking (csi-Mask) is setup by upper layers:
3> in current symbol n, if drx-onDurationTimer of a DRX group would not be running considering grants/assignments scheduled on Serving Cell(s) in this DRX group and DRX Command MAC CE/Long DRX Command MAC CE received until 4 ms prior to symbol n when evaluating all DRX Active Time conditions as specified in this clause; and
3> if allowCSI-SRS-Tx-MulticastDRX-Active is not configured, or in current symbol n, if drx-onDurationTimerPTM of multicast DRX of all configured multicast services would not be running considering grants/assignments when evaluating all multicast DRX Active Time conditions as specified in clause 5.7b:
4> not report CSI on PUCCH in this DRX group.

If the UE (100) multiplexes the CSI configured on PUCCH with other overlapping uplink control information (UCI) according to the procedure specified in TS 38.213 [6] clause 9.2.5 and this CSI multiplexed with other UCI would be reported on a PUCCH resource either outside the DRX active Ttime of the DRX group in which this PUCCH is configured or if the allowCSI-SRS-Tx-MulticastDRX-Active is configured, DRX active time of the multicast DRX or outside the on-duration period of the DRX group in which this PUCCH is configured or if allowCSI-SRS-Tx-MulticastDRX-Active is configured, outside the on-duration period of the multicast DRX if CSI masking is setup by upper layers, it is based on UE (100) implementation whether this CSI multiplexed with other UCIs is reported.

An alternative for the DRX method is provided below:

<Text Omitted>
1> if DCP monitoring is configured for the active DL BWPas specified in TS 38.213 [6], clause 10.3; and
1> if the current symbol n occurs within drx-onDurationTimer duration; and
1> if drx-onDurationTimer associated with the current DRX cycle is not started as specified in this clause:
2> if the MAC entity would not be in Active Time considering grants/assignments/DRX Command MAC CE/Long DRX Command MAC CE received and Scheduling Request sent until 4 ms prior to symbol n when evaluating all DRX Active Time conditions as specified in this clause:
3> not transmit periodic SRS and semi-persistent SRS defined in TS 38.214 [7];
3> not report semi-persistent CSIconfigured on PUSCH;
3> if ps-TransmitPeriodicLI-RSRP is not configured with value true:
4> not report periodic CSI that is L1-RSRP on PUCCH.
3> ifps-TransmitOtherPeriodicCSIis not configured with value true:
4> not report periodic CSI that is not L1-RSRP on PUCCH.
1> else:
2> in current symbol n, if a DRX group would not be in Active Time considering grants/assignments scheduled on Serving Cell(s) in this DRX group and DRX Command MAC CE/Long DRX Command MAC CE received and Scheduling Request sent until 4 ms prior to symbol n when evaluating all DRX Active Time conditions as specified in this clause; and
2> if allowCSI-SRS-Tx-MulticastDRX-Active is not configured, or in current symbol n, if multicast DRX of all configured multicast services would not be in Active Time considering multicast grants/assignments when evaluating all multicast DRX Active Time conditions as specified in clause 5.7b:
3> not transmit periodic SRS and semi-persistent SRS defined in TS 38.214 [7] in this DRX group;
3> not report CSI on PUCCH and semi-persistent CSI configured on PUSCH in this DRX group.
2> if CSI masking (csi-Mask) is setup by upper layers:
3> in current symbol n, if drx-onDurationTimer of a DRX group would not be running considering grants/assignments scheduled on Serving Cell(s) in this DRX group and DRX Command MAC CE/Long DRX Command MAC CE received until 4 ms prior to symbol n when evaluating all DRX Active Time conditions as specified in this clause:
4> not report CSI on PUCCH in this DRX group.

An alternative for the discontinuous reception method is provided below:

<Text Omitted>
1> if DCP monitoring is configured for the active DL BWPas specified in TS 38.213 [6], clause 10.3; and
1> if the current symbol n occurs within drx-onDurationTimer duration; and
1> if drx-onDurationTimer associated with the current DRX cycle is not started as specified in this clause:
2> if the MAC entity would not be in Active Time considering grants/assignments/DRX Command MAC CE/Long DRX Command MAC CE received and Scheduling Request sent until 4 ms prior to symbol n when evaluating all DRX Active Time conditions as specified in this clause:
3> not transmit periodic SRS and semi-persistent SRS defined in TS 38.214 [7];
3> not report semi-persistent CSIconfigured on PUSCH;
3> if ps-TransmitPeriodicLI-RSRP is not configured with value true:
4> not report periodic CSI that is L1-RSRP on PUCCH.
3> ifps-TransmitOtherPeriodicCSIis not configured with value true:
4> not report periodic CSI that is not L1-RSRP on PUCCH.
1> else:
2> in current symbol n, if a DRX group would not be in Active Time considering grants/assignments scheduled on Serving Cell(s) in this DRX group and DRX Command MAC CE/Long DRX Command MAC CE received and Scheduling Request sent until 4 ms prior to symbol n when evaluating all DRX Active Time conditions as specified in this clause; and
2> if allowSRS-Tx-MulticastDRX-Active is not configured, or in current symbol n, if multicast DRX of all configured multicast services would not be in Active Time considering multicast grants/assignments when evaluating all multicast DRX Active Time conditions as specified in clause 5.7b:
3> not transmit periodic SRS and semi-persistent SRS defined in TS 38.214 [7] in this DRX group;
2> if allowCSI-Tx-MulticastDRX-Active is not configured, or in current symbol n, if multicast DRX of all configured multicast services would not be in Active Time considering multicast grants/assignments when evaluating all multicast DRX Active Time conditions as specified in clause 5.7b:
3> not report CSI on PUCCH and semi-persistent CSI configured on PUSCH in this DRX group.
2> if CSI masking (csi-Mask) is setup by upper layers:
3> in current symbol n, if drx-onDurationTimer of a DRX group would not be running considering grants/assignments scheduled on Serving Cell(s) in this DRX group and DRX Command MAC CE/Long DRX Command MAC CE received until 4 ms prior to symbol n when evaluating all DRX Active Time conditions as specified in this clause; and
3> if allowCSI-Tx-MulticastDRX-Active is not configured, or in current symbol n, if drx-onDurationTimerPTM of multicast DRX of all configured multicast services would not be running considering grants/assignments when evaluating all multicast DRX Active Time conditions as specified in clause 5.7b:
4> not report CSI on PUCCH in this DRX group.

When the UE (100) multiplexes a CSI configured on PUCCH with other overlapping UCI(s) according to the procedure specified in TS 38.213 [6] clause 9.2.5 and this CSI multiplexed with other UCI(s) would be reported on a PUCCH resource either outside the DRX active time of the DRX group in which this PUCCH is configured or if allowCSI-SRS-Tx-MulticastDRX-Active is configured, DRX active time of the multicast DRX or outside the on-duration period of the DRX group in which this PUCCH is configured or if allowCSI-SRS-Tx-MulticastDRX-Active is configured, outside the on-duration period of the multicast DRX if CSI masking is setup by upper layers, it is based on the UE (100) implementation whether this CSI multiplexed with other UCI is reported.

When the UE (100) transitions from RRC_CONNECTED state to RRC_INACTIVE state and continues receiving multicast service(s), the network explicitly reconfigures the UE (100) wherein the indication(s) or configuration(s) that allow CSI reporting and/or SRS transmission in multicast DRX active time and non-active time of unicast DRX are released or removed.

When the UE (100) transitions from RRC_INACTIVE state to RRC_CONNECTED state and continues receiving multicast service(s), the network explicitly reconfigures the UE (100) wherein the indication(s) or configuration(s) that allow CSI reporting and/or SRS transmission in multicast DRX active time and non-active time of unicast DRX are setup or added.

When the UE (100) transitions from RRC_CONNECTED state to RRC_INACTIVE state and continues receiving multicast service(s), the UE (100) discontinues or invalidates the indication(s) or configuration(s) that allow CSI reporting and/or SRS transmission in multicast DRX active time and non-active time of unicast DRX. UE (100) may store the indication(s) or configuration(s) during the RRC state change.

When the UE (100) transitions from the RRC_INACTIVE state to the RRC_CONNECTED state and continues receiving multicast service(s), the UE (100) continues or validates the stored indication(s) or configuration(s) that allow CSI reporting and/or SRS transmission in multicast DRX active time and non-active time of unicast DRX.

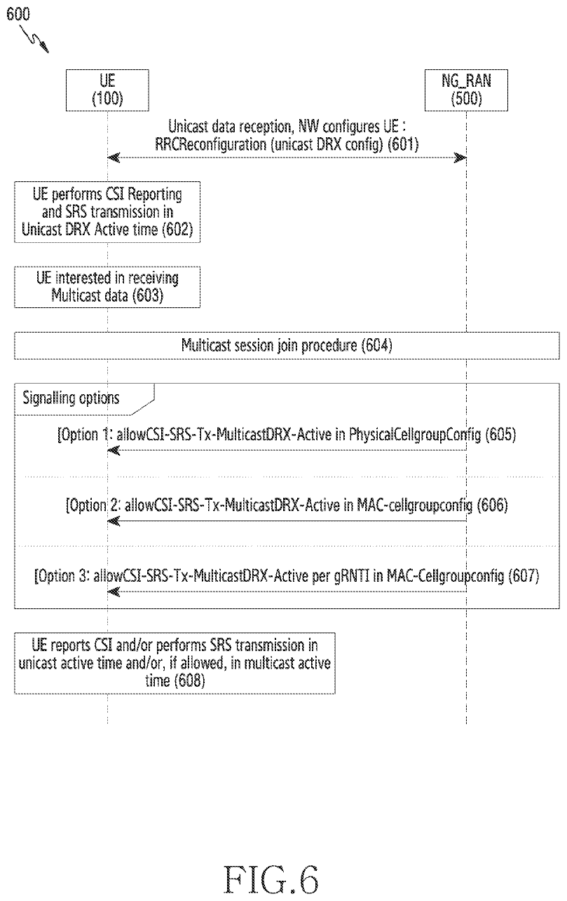

FIG. 6 illustrates various signaling options in for controlling the transmission of SRS and reporting of CSI, according to an embodiment.

In step 601, the next-generation radio access network (NG_RAN) (500) signals and configures the UE (100) through unicast data reception in RRCReconfiguration (including unicast DRX config).

In step 602, the UE (100) performs CSI Reporting and SRS transmission in unicast DRX active time.

In step 603, the UE (100) indicates its interest in receiving multicast data and in step 604, the UE (100) and NG_RAN (500) perform a multicast session join procedure.

In step 605, in signaling Option 1, allowCSI-SRS-Tx-MulticastDRX-Active parameter is provided in a PhysicalCellgroupConfig information element (IE) in the RRCReconfiguration message (e.g. this may include MBS Config, MBS DRX config, PhysicalCellGroupConfig (allowCSI-SRS-Tx-MulticastDRX-Active)) In step 606, in signaling Option 2, allowCSI-SRS-Tx-MulticastDRX-Active parameter is provided in MAC-CellGroupConfig IE in the RRCReconfiguration message (e.g. this may include MBS Config, MBS DRX config, MAC-CellGroupConfig (allowCSI-SRS-Tx-MulticastDRX-Active)).

In step 607, in signaling Option 3, allowCSI-SRS-Tx-MulticastDRX-Active parameter is provided per gRNTI in MAC-CellGroupConfig IE in the RRCReconfiguration message (e.g. this may include MBS Config, MBS DRX config, MAC-CellGroupConfig (allowCSI-SRS-Tx-MulticastDRX-Active per gRNTI)).

In step 608, the UE (100) reports CSI and/or performs SRS transmission in the unicast active time and/or, if allowed, in the multicast active time.

For handling of CSI reporting and SRS transmission, the network provides an indication or configuration (referred to as allowCSI-SRS-Tx-MulticastDRX-Active) to the UE (100) to allow or disallow CSI reporting and/or SRS transmission in the multicast DRX active time and non-active time of unicast DRX. The allowCSI-SRS-Tx-MulticastDRX-Active can be at least one of a field, a set of fields, a bit, a bitmap and can represent one or more combinations of the following: Indication or configuration to allow or disallow CSI reporting in the PUCCH, indication or configuration to allow or disallow semi-persistent CSI reporting in the PUSCH, indication or configuration to allow or disallow SRS transmission, and indication or configuration to allow or disallow Semi-persistent SRS transmission.

The indication or configuration may be explicitly indicated as TRUE/FALSE or allow/disallow or may also be interpreted as the presence of indication or configuration implying allow and the absence of indication or configuration implying disallow.

Alternatives for such indication or configuration are now provided as examples but are not limited thereto.

Alternative 1 for indication or configuration is a single indication or configuration to allow or disallow CSI reporting in PUCCH/semi persistent CSI reporting in PUSCH and/or SRS/semi persistent SRS transmission in multicast DRX active time and non-active time of unicast DRX.

Alternative 2 for indication or configuration is an indication or configuration to allow or disallow CSI reporting in PUCCH/semi persistent CSI reporting in PUSCH in multicast DRX Active time and non-active time of unicast DRX. Indication or configuration to allow or disallow SRS/semi persistent SRS transmission in multicast DRX active time and non-active time of unicast DRX.

Alternative 3 for indication or configuration is an indication or configuration to allow or disallow CSI reporting in PUCCH in multicast DRX active time and non-active time of unicast DRX. Further indication or configuration to allow or disallow semi persistent CSI reporting in PUSCH in multicast DRX active time and non-active time of unicast DRX. Further indication or configuration to allow or disallow SRS/semi persistent SRS transmission in multicast DRX active time and non-Active time of unicast DRX.

The above-described indications or configurations can be signaled as part of at least one of the following: Option 1 as part of PhysicalCellGroupConfig is an indication or configuration for the UE (100) to perform CSI reporting and/or SRS transmission in multicast DRX Active time and unicast DRX non-Active time as part of PhysicalCellGroupConfig.

Alternative 1:

| | |
|---|---|
| MulticastConfig-r17 ::= | SEQUENCE { pdsch-HARQ-ACK- |

CodebookListMulticast-r17 SetupRelease {PDSCH-HARQ-ACK-CodebookList-r16}

| | |
|---|---|
| type1-Codebook-GenerationMode-r17 | ENUMERATED { mode1, mode2} |
| g-CS-RNTI-ConfigToAddModList-r17 | SEQUENCE (SIZE (1..maxG-CS-RNTI- |

r17)) OF G-CS-RNTI-Config-r17

| | |
|---|---|
| g-CS-RNTI-ConfigToReleaseList-r17 | SEQUENCE (SIZE (1..maxG-CS-RNTI-r17)) |

OF G-CS-RNTI-ConfigId-r17

| | |
|---|---|
| allowCSI-SRS-Tx-MulticastDRX-Active | BOOLEAN |

```
  }
  Alternative 2:
```

| | |
|---|---|
| MulticastConfig-r17 ::= | SEQUENCE { pdsch-HARQ-ACK- |

CodebookListMulticast-r17 SetupRelease { PDSCH-HARQ-ACK-CodebookList-r16}

| | |
|---|---|
| type1-Codebook-GenerationMode-r17 | ENUMERATED { mode1, mode2} |
| g-CS-RNTI-ConfigToAddModList-r17 | SEQUENCE (SIZE (1..maxG-CS-RNTI- |

r17)) OF G-CS-RNTI-Config-r17

| | |
|---|---|
| g-CS-RNTI-ConfigToReleaseList-r17 | SEQUENCE (SIZE (1..maxG-CS-RNTI-r17)) |

OF G-CS-RNTI-ConfigId-r17

| | |
|---|---|
| allowCSI-Tx-MulticastDRX-Active | BOOLEAN |
| allowSRS-Tx-MulticastDRX-Active | BOOLEAN |

```
  }
  Alternative 3:
```

| | |
|---|---|
| MulticastConfig-r17 ::= | SEQUENCE { pdsch-HARQ-ACK- |

CodebookListMulticast-r17 SetupRelease { PDSCH-HARQ-ACK-CodebookList-r16}

| | |
|---|---|
| type1-Codebook-GenerationMode-r17 | ENUMERATED { mode1, mode2} |
| g-CS-RNTI-ConfigToAddModList-r17 | SEQUENCE (SIZE (1..maxG-CS-RNTI- |

r17)) OF G-CS-RNTI-Config-r17 g-CS-RNTI-ConfigToReleaseList-r17 SEQUENCE
(SIZE (1..maxG-CS-RNTI-r17)) OF G-CS-RNTI-ConfigId-r17

| | |
|---|---|
| allowPucchCSI-Tx-MulticastDRX-Active | BOOLEAN |
| allowPuschSpCSI-Tx-MulticastDRX-Active | BOOLEAN |
| allowSRS-Tx-MulticastDRX-Active | BOOLEAN |

```
  ]]
  }
```

Option 2a as part of MAC-CellGroupConfig is an indication or configuration for the UE (100) to perform CSI reporting and/or SRS transmission in multicast DRX Active time and unicast non-Active time commonly for all configured MBS multicast services as part of MAC-CellGroupConfig. Sample depictions of changes to ASN structure (e.g. achievement standards network structure) for realizing Option 2a are as follows

Alternative 1:

| | |
|---|---|
| MAC-CellGroupConfig ::= | SEQUENCE { |

[[

| | |
|---|---|
| g-RNTI-ConfigToAddModList-r17 | SEQUENCE (SIZE (1..maxG-RNTI-r17)) OF |

G-RNTI-Config-r17

| | |
|---|---|
| g-RNTI-ConfigToReleaseList-r17 | SEQUENCE (SIZE (1..maxG-RNTI-r17)) OF G- |

RNTI-ConfigId-r17

| | |
|---|---|
| allowCSI-SRS-Tx-MulticastDRX-Active | BOOLEAN |

```
  ]]
  }
  Alternative 2:
```

| | |
|---|---|
| MAC-CellGroupConfig ::= | SEQUENCE { |

[[

| | |
|---|---|
| g-RNTI-ConfigToAddModList-r17 | SEQUENCE (SIZE (1..maxG-RNTI-r17)) OF |

G-RNTI-Config-r17

| | |
|---|---|
| g-RNTI-ConfigToReleaseList-r17 | SEQUENCE (SIZE (1..maxG-RNTI-r17)) OF G- |

RNTI-ConfigId-r17

| | |
|---|---|
| allowCSI-Tx-MulticastDRX-Active | BOOLEAN |
| allowSRS-Tx-MulticastDRX-Active | BOOLEAN |

```
  ]]
  }
  Alternative 3:
```

| | |
|---|---|
| MAC-CellGroupConfig ::= | SEQUENCE { |

[[

| | |
|---|---|
| g-RNTI-ConfigToAddModList-r17 | SEQUENCE (SIZE (1..maxG-RNTI-r17)) OF |

G-RNTI-Config-r17

| | |
|---|---|
| g-RNTI-ConfigToReleaseList-r17 | SEQUENCE (SIZE (1..maxG-RNTI-r17)) OF G- |

RNTI-ConfigId-r17

| | |
|---|---|
| allowPucchCSI-Tx-MulticastDRX-Active | BOOLEAN |
| allowPuschSpCSI-Tx-MulticastDRX-Active | BOOLEAN |
| allowSRS-Tx-MulticastDRX-Active | BOOLEAN]] |

}

Option 2b is the indication or configuration for the UE (100) to perform CSI reporting and/or SRS transmission in multicast DRX active time and unicast non-active time per configured MBS multicast service as part of G-RNTI-Config-r17 in MAC-CellGroupConfig. Sample depiction of changes to the ASN structure for realizing Option 2b are as follows:

Alternative 1:

| | |
|---|---|
| G-RNTI-Config-r17 ::= | SEQUENCE { |
| g-RNTI-ConfigId-r17 | G-RNTI-ConfigId-r17, |
| g-RNTI-r17 | RNTI-Value, |
| drx-ConfigPTM-r17 | SetupRelease { DRX-ConfigPTM-r17 } |
| harq-FeedbackEnablerMulticast-r17 | ENUMERATED {dci-enabler, enabled} |
| harq-FeedbackOptionMulticast-r17 | ENUMERATED {ack-nack, nack-only} |
| pdsch-AggregationFactorMulticast-r17 | ENUMERATED {n2, n4, n8} |
| allowCSI-SRS-Tx-MulticastDRX-Active | BOOLEAN |

}
Alternative 2:

| | |
|---|---|
| G-RNTI-Config-r17 ::= | SEQUENCE { |
| g-RNTI-ConfigId-r17 | G-RNTI-ConfigId-r17, |
| g-RNTI-r17 | RNTI-Value, |
| drx-ConfigPTM-r17 | SetupRelease { DRX-ConfigPTM-r17 } |
| harq-FeedbackEnablerMulticast-r17 | ENUMERATED {dci-enabler, enabled} |
| harq-FeedbackOptionMulticast-r17 | ENUMERATED {ack-nack, nack-only} |
| pdsch-AggregationFactorMulticast-r17 | ENUMERATED {n2, n4, n8} |
| allowCSI-Tx-MulticastDRX-Active | BOOLEAN |
| allowSRS-Tx-MulticastDRX-Active | BOOLEAN |

}
Alternative 3:

| | |
|---|---|
| G-RNTI-Config-r17 ::= | SEQUENCE { |
| g-RNTI-ConfigId-r17 | G-RNTI-ConfigId-r17, |
| g-RNTI-r17 | RNTI-Value, |
| drx-ConfigPTM-r17 | SetupRelease { DRX-ConfigPTM-r17 } |
| harq-FeedbackEnablerMulticast-r17 | ENUMERATED {dci-enabler, enabled} |
| harq-FeedbackOptionMulticast-r17 | ENUMERATED {ack-nack, nack-only} |
| pdsch-AggregationFactorMulticast-r17 | ENUMERATED {n2, n4, n8} |
| allowPucchCSI-Tx-MulticastDRX-Active | BOOLEAN |
| allowPuschSpCSI-Tx-MulticastDRX-Active | BOOLEAN |
| allowSRS-Tx-MulticastDRX -Active | BOOLEAN]] |

}

CSI-masking which is setup by upper layers is applied to one of only unicast DRX operation (i.e., is inapplicable to multicast DRX operation) or both unicast and multicast DRX operation.

CSI-masking which is setup by upper layers is applied to one of CSI reporting pertaining to the unicast or both unicast and MBS multicast.

The following approaches are shown for changes to MAC layer specification (3GPP TS 38.321) to support the handling of CSI reporting/SRS transmission during an MBS multicast DRX active period and a unicast DRX non active period. However, these alternatives are examples and the scope of the disclosure is not limited thereto.

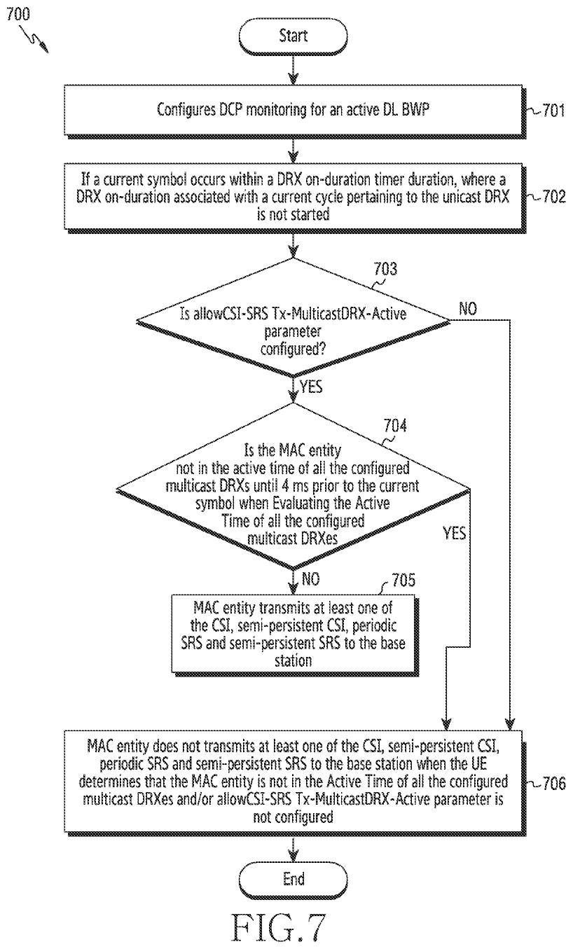

FIG. 7 is a flow chart (700) illustrating a process of controlling the transmission of SRS and reporting of CSI when the UE (100) is configured with DCP monitoring, according to an embodiment.

In step 701, the NG-RAN (500) configures DCP monitoring for an active DL BWP.

In step 702, the UE (100) determines whether the current symbol occurs within the DRX on-duration timer duration, where the DRX on-duration associated with the current cycle pertaining to the unicast DRX is not started.

In step 703, the UE (100) determines whether an allowCSI-SRS Tx-MulticastDRX-Active parameter is configured.

In step 704, the UE (100) determines whether the MAC entity is not in the active time of all the configured multicast DRXs until 4 ms prior to the current symbol when evaluating the active time of all the configured multicast DRXs when the allowCSI-SRS-Tx-MulticastDRX-Active parameter is configured.

In step 705, the UE (100) determines whether MAC entity transmits the at least one of the CSI, semi-persistent CSI, periodic SRS and semi-persistent SRS to the base station when the MAC entity is not in the active time of all the configured multicast DRXs until 4 ms prior to the current symbol when evaluating the active time of all the configured multicast DRXs when the allowCSI-SRS-Tx-MulticastDRX-Active parameter is configured.

In step 706, the MAC entity does not transmit the at least one of the CSI, semi-persistent CSI, periodic SRS and semi-persistent SRS to the base station when the UE (100) determines that the MAC entity is not in the active time of all the configured multicast DRXs and/or when the allowCSI-SRS-Tx-MulticastDRX-Active parameter is not configured.

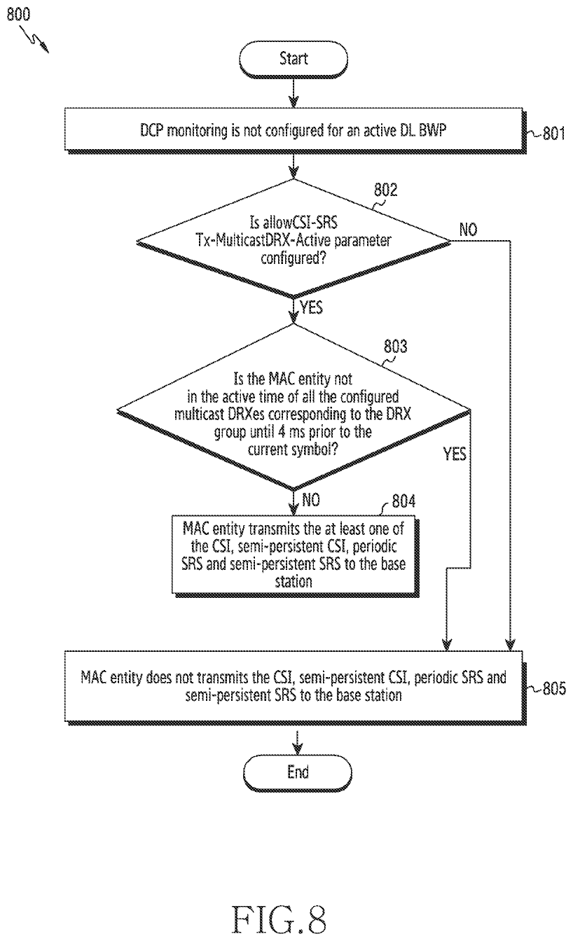

FIG. 8 is a flow chart (800) illustrating a process of controlling the transmission of SRS and reporting of CSI when the UE (100) is not configured with the DCI monitoring, according to an embodiment.

In step 801, DCP monitoring is not configured for the active DL BWP.

In step 802, the UE (100) determines whether the allowCSI-SRS-Tx-MulticastDRX-Active parameter is configured.

In step 803, the UE (100) determines whether the MAC entity is not in the active time of all the configured multicast DRXs corresponding to the DRX group until 4 ms prior to the current symbol when the allowCSI-SRS-Tx-MulticastDRX-Active parameter is configured.

In step 804, the MAC entity transmits the at least one of the CSI, semi-persistent CSI, periodic SRS and semi-persistent SRS to the base station when the MAC entity is not in the active time of all the configured multicast DRXs corresponding to the DRX group until 4 ms prior to the current symbol.

In step 805, the MAC entity does not transmit the CSI, semi-persistent CSI, periodic SRS and semi-persistent SRS to the base station when the MAC entity is not in the active time of all the configured multicast DRXs corresponding to the DRX group until 4 ms prior to the current symbol and when the allowCSI-SRS-Tx-MulticastDRX-Active parameter is not configured.

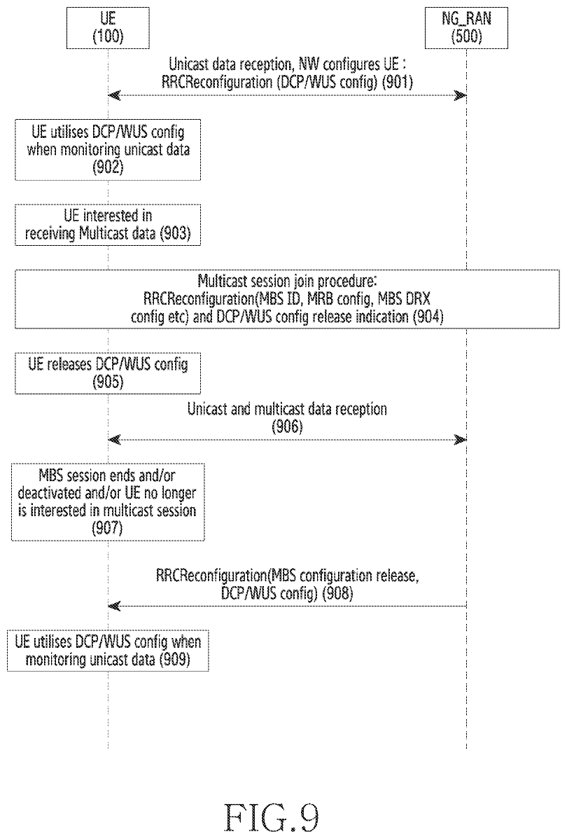

FIG. 9 illustrates the DCP/WUS configuration release and setup along with the multicast DRX configuration and release, according to an embodiment.

In step 901, the NG_RAN (500) signals and configures UE (100) for unicast data reception in an RRCReconfiguration message (this may include DCP/WUS config).

In step 902, the UE (100) utilizes DCP/WUS config when monitoring unicast data.

In step 903, the UE (100) indicates its interest in receiving multicast data and in step 904, the UE (100) and NG_RAN (500) perform a multicast session join procedure i.e.

RRCReconfiguration message (this may include MBS ID, MRB config, MBS DRX config etc.) and DCP/WUS config release indication.

In step 905, the UE (100) releases DCP/WUS config.

In step 906, unicast and multicast data reception is performed between the UE (100) and NG_RAN (500).

In step 907, the MBS session ends and/or the UE (100) is no longer interested in participating in the multicast session.

In step 908, UE receives an RRCReconfiguration message (this may include MBS configuration release and DCP/WUS config) from the NG_RAN (500).

In step 909, the UE (100) utilizes DCP/WUS config when monitoring unicast data.

When the UE (100) is configured with setup of the multicast DRX for at least one MBS multicast service, the network explicitly reconfigures UE (100) with removing or releasing the DCP-Config. When the UE (100) is configured with release of the multicast DRX of all MBS multicast services, the network explicitly reconfigures the UE (100) by adding or setting up the DCP-Config.

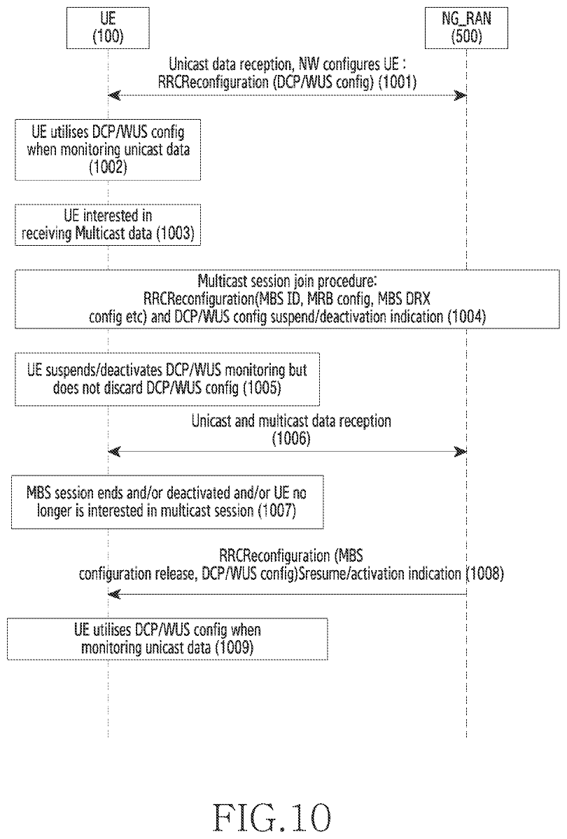

FIG. 10 illustrates a procedure for DCP/WUS configuration deactivation and activation along with the multicast DRX configuration and release, according to an embodiment.

In step 1001, the NG_RAN (500) signals and configures UE (100) for unicast data reception in RRCReconfiguration message (this may include DCP/WUS config).

In step 1002, the UE (100) utilizes DCP/WUS config when monitoring unicast data.

In step 1003, the UE (100) indicates its interest in receiving multicast data and in step 904, the UE (100) and NG_RAN (500) perform a multicast session join procedure i.e.

RRCReconfiguration message (this may include MBS ID, MRB config, MBS DRX config etc.) and perform a DCP/WUS config suspend/deactivation indication.

In step 1005, the UE (100) suspends/deactivates DCP/WUS monitoring but does not discard the DCP/WUS config.

In step 1006, unicast and multicast data reception is performed between the UE (100) and NG_RAN (500).

In step 1007, an MBS session ends and/or is deactivated and/or the UE (100) is no longer interested in participating in the multicast session.

In step 1008, UE receives an RRCReconfiguration message (this may include MBS configuration release, DCP/WUS config resume/activation indication).

In step 1009, the UE (100) utilizes DCP/WUS config when monitoring unicast data.

When the UE (100) is configured with setup of the multicast DRX for at least one MBS multicast service, the network explicitly indicates to the UE (100) for the suspension or inactivation of the DCP-Config. When UE (100) is configured with release of the multicast DRX of all MBS multicast services, the network explicitly indicates to the UE (100) for the resumption or activation of the DCP-Config.

A sample ASN structure depicting the network signaling of DCP-config suspension/inactivation is as follows:

PhysicalCellGroupConfig

| | |
|---|---|
| PhysicalCellGroupConfig ::= | SEQUENCE { |

```
  .......
    [[
```

| | |
|---|---|
| multicastConfig-r17 | MulticastConfig-r17 |

```
  ]]
  .......
  }
```

| | |
|---|---|
| MulticastConfig-r17 ::= | SEQUENCE { |

pdsch-HARQ-ACK-CodebookListMulticast-r17 SetupRelease { PDSCH-HARQ-ACK-
CodebookList-r16}

| | |
|---|---|
| type1-Codebook-GenerationMode-r17 | ENUMERATED { mode1, mode2} |
| g-CS-RNTI-ConfigToAddModList-r17 | SEQUENCE (SIZE (1..maxG-CS-RNTI- |

r17)) OF G-CS-RNTI-Config-r17

| | |
|---|---|
| g-CS-RNTI-ConfigToReleaseList-r17 | SEQUENCE (SIZE (1..maxG-CS-RNTI-r17)) |

OF G-CS-RNTI-ConfigId-r17

| | |
|---|---|
| disable-UnicastDCPConfig | BOOLEAN |

}

A disable-UnicastDCPConfig indication is sent as part of PhysicalCellGroupConfig and if signaled as true, and indicates that the unicast DCP configuration if already configured to the UE (100) will be considered as inactivated or suspended. The Network signaling suspension or inactivation of DCP-Config is provided below: If DCP-config is signaled as inactivated or suspended:
2> Consider the DCP monitoring as not configured regardless of availability of configuration for that DL BWP
1> if DCP monitoring is configured for the active DL BWPas specified in TS 38.213 [6], clause 10.3 and DCP-Config is not signalled as inactivated or suspended; and
1> if the current symbol n occurs within drx-onDurationTimer duration; and
1> if drx-onDurationTimer associated with the current DRX cycle is not started as specified in this clause:
2> if the MAC entity would not be in Active Time considering grants/assignments/DRX Command MAC CE/Long DRX Command MAC CE received and Scheduling Request sent until 4 ms prior to symbol n when evaluating all DRX Active Time conditions as specified in this clause:
3> not transmit periodic SRS and semi-persistent SRS defined in TS 38.214 [7];
3> not report semi-persistent CSIconfigured on PUSCH;
3> if ps-TransmitPeriodicL1-RSRP is not configured with value true:
4> not report periodic CSI that is L1-RSRP on PUCCH.
3> ifps-TransmitOtherPeriodicCSIis not configured with value true:
4> not report periodic CSI that is not L1-RSRP on PUCCH.

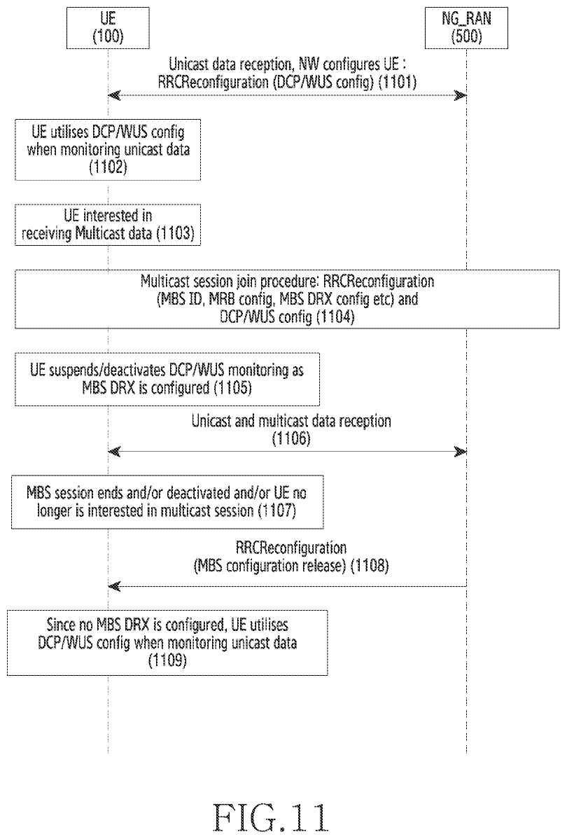

FIG. 11 illustrates procedure for the UE (100) based DCP/WUS configuration local suspension and local resumption along with the multicast DRX configuration and release, according to an embodiment.

In step 1101, the NG_RAN (500) signals and configures the UE (100) through unicast data reception in RRCReconfiguration (DCP/WUS config).

In step 1102, the UE (100) utilizes DCP/WUS config when monitoring unicast data.

In step 1103, the UE (100) indicates its interest in receiving multicast data and in step 1104, the UE (100) and NG_RAN (500) perform a multicast session join procedure i.e.

RRCReconfiguration (MBS ID, MRB config, MBS DRX config etc.) and DCP/WUS config.

In step 1105, the UE (100) suspends/deactivates DCP/WUS monitoring as MBS DRX is configured.

In step 1106, unicast and multicast data reception is performed between the UE (100) and NG_RAN (500).

In step 1107, an MBS session ends and/or is deactivated and/or the UE (100) is no longer interested in participating in the multicast session.

In step 1108, the NG_AN (500) transmits a RRCReconfiguration (i.e., MBS configuration release) to the UE (100).

In step 1109, the UE (100) utilizes DCP/WUS config when monitoring unicast data since no MBS DRX is configured.

When the UE (100) is configured with setup of the multicast DRX for at least one MBS multicast service, the UE (100) locally invalidates or suspends the configured DCP-Config. When UE (100) is configured with release of the multicast DRX of all MBS multicast services, the UE (100) locally validates or resumes the configured DCP-Config.

Specifically, the UE (100) locally invalidates or suspends DCP-Config as provided below: If at least one Multicast DRX is configured:
2> Consider the DCP monitoring as not configured regardless of availability of configuration for that DL BWP
1> if DCP monitoring is configured for the active DL BWPas specified in TS 38.213 [6], clause 10.3; and
1> if multicast DRX is not configured; and
1> if the current symbol n occurs within drx-onDurationTimer duration; and
1> if drx-onDurationTimer associated with the current DRX cycle is not started as specified in this clause:
2> if the MAC entity would not be in Active Time considering grants/assignments/DRX Command MAC CE/Long DRX Command MAC CE received and Scheduling Request sent until 4 ms prior to symbol n when evaluating all DRX Active Time conditions as specified in this clause:
3> not transmit periodic SRS and semi-persistent SRS defined in TS 38.214 [7];
3> not report semi-persistent CSIconfigured on PUSCH;
3> if ps-TransmitPeriodicLI-RSRP is not configured with value true:
4> not report periodic CSI that is L1-RSRP on PUCCH.
3> ifps-TransmitOtherPeriodicCSIis not configured with value true:
4> not report periodic CSI that is not L1-RSRP on PUCCH.

When UE (100) is switched from a PTP bearer to the PTM bearer or from the PTP bearer to a split-MBS bearer for at least one MBS multicast service, the network explicitly reconfigures UE (100) with removing or releasing the DCP-Config. When the UE (100) is switched from the PTM bearer to the PTP bearer or from the split-MBS bearer to the PTP bearer for all configured MBS multicast services, the network explicitly reconfigures the UE (100) with adding or setting up the DCP-Config.

When the UE (100) is switched from the PTP bearer to the PTM bearer or from the PTP bearer to the split-MBS bearer for at least one MBS multicast service, the network explicitly indicates to the UE (100) for the suspension or inactivation of the DCP-Config. When the UE (100) is switched from the PTM bearer to the PTP bearer or from the split-MBS bearer to the PTP bearer for all configured MBS multicast services, the network explicitly indicates to the UE (100) for the resumption or activation of the DCP-Config.

When the UE (100) is switched from the PTP bearer to the PTM bearer or from the PTP bearer to the split-MBS bearer for at least one MBS multicast service, the UE (100) locally invalidates or suspends the configured DCP-Config. When the UE (100) is switched from the PTM bearer to the PTP bearer or from the split-MBS bearer to the PTP bearer for all configured MBS multicast services, UE (100) locally validates or resumes the configured DCP-Config.

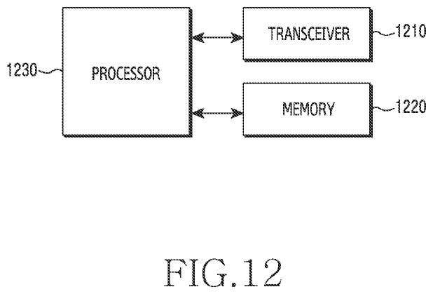

FIG. 12 is a block diagram of a structure of a UE, according to an embodiment.

As shown in FIG. 12, the UE may include a transceiver (1210), a memory (1220), and a processor (1230). The transceiver (1210), the memory (1220), and the processor (1230) of the UE may operate according to a communication method of the UE described above. However, the components of the UE are not limited thereto. For example, the UE may include more or fewer components than those described above. In addition, the processor (1230), the transceiver (1210), and the memory (1220) may be implemented as a single chip. Also, the processor (1230) may include at least one processor. Furthermore, the UE of FIG. 12 corresponds to the UE (100) of the FIG. 1.

The transceiver (1210) collectively refers to a UE receiver and a UE transmitter, and may transmit/receive a signal to/from a base station or a network entity. The signal transmitted or received to or from the base station or a network entity may include control information and data. The transceiver (1210) may include an RF transmitter for up-converting and amplifying a frequency of a transmitted signal, and an RF receiver for amplifying low-noise and down-converting a frequency of a received signal. However, this is only an example of the transceiver (1210) and components of the transceiver (1210) are not limited to the RF transmitter and the RF receiver.

The transceiver (1210) may receive and output, to the processor (1230), a signal through a wireless channel, and transmit a signal output from the processor (1230) through the wireless channel.

The memory (1220) may store a program and data required for operations of the UE. Also, the memory (1220) may store control information or data included in a signal obtained by the UE. The memory (1220) may be a storage medium, such as read-only memory (ROM), random access memory (RAM), a hard disk, a CD-ROM, and a DVD, or a combination of storage media.

The processor (1230) may control a series of processes such that the UE operates as described above. For example, the transceiver (1210) may receive a data signal including a control signal transmitted by the base station or the network entity, and the processor (1230) may determine a result of receiving the control signal and the data signal transmitted by the base station or the network entity.

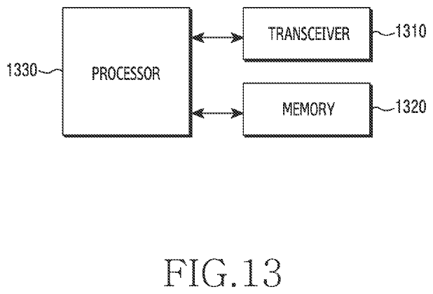

FIG. 13 is a block diagram of a structure of a base station (BS), according to an embodiment.

As shown in FIG. 13, the BS may include a transceiver (1310), a memory (1320), and a processor (1330). The transceiver (1310), the memory (1320), and the processor (1330) of the BS may operate according to a communication method of the BS described above. However, the components of the BS are not limited thereto. For example, the BS may include more or fewer components than those described above. In addition, the processor (1330), the transceiver (1310), and the memory (1320) may be implemented as a single chip. The processor (1330) may include at least one processor.

The transceiver (1310) collectively refers to a BS receiver and a BS transmitter, and may transmit/receive a signal to/from a terminal (UE) or a network entity. The signal transmitted or received to or from the terminal or a network entity may include control information and data. The transceiver (1310) may include an RF transmitter for up-converting and amplifying a frequency of a transmitted signal, and an RF receiver for amplifying low-noise and down-converting a frequency of a received signal. However, this is only an example of the transceiver (1310) and components of the transceiver (1310) are not limited to the RF transmitter and the RF receiver.

The transceiver (1310) may receive and output, to the processor (1330), a signal through a wireless channel, and transmit a signal output from the processor (1330) through the wireless channel.

The memory (1320) may store a program and data required for operations of the BS. Also, the memory (1320) may store control information or data included in a signal obtained by the BS. The memory (1320) may be a storage medium, such as read-only memory (ROM), random access memory (RAM), a hard disk, a CD-ROM, and a DVD, or a combination of storage media.

The processor (1330) may control a series of processes such that the base station operates as described above. For example, the transceiver (1310) may receive a data signal including a control signal transmitted by the terminal, and the processor (1330) may determine a result of receiving the control signal and the data signal transmitted by the terminal.

In one embodiment, a method performed by a user equipment (UE) in a wireless communication includes receiving, from a base station, configuration information indicating whether a transmission of channel state information (CSI) or sounding reference signal (SRS) during multicast and broadcast service (MBS) multicast discontinuous reception (DRX) active time is allowed, and identifying whether to transmit the CSI or the SRS within the MBS multicast DRX active time and outside a unicast DRX active time, based on the configuration information, wherein, in case that the transmission of the CSI or the SRS during the MBS multicast DRX active time is allowed based on the configuration information, the CSI or the SRS is transmitted within the MBS multicast DRX active time and outside the unicast DRX active time.

In one embodiment, the CSI or the SRS is not transmitted in case that the transmission of the CSI or the SRS during the MBS multicast DRX active time is not allowed based on the configuration information.

In one embodiment, the method further includes receiving, from the base station, information for configuring a CSI mask, the CSI is not transmitted in case that the transmission of the CSI during the MBS multicast DRX active time is not allowed based on the configuration information and the CSI mask, and the CSI is transmitted within the MBS multicast DRX active time and outside the unicast DRX active time in case that the transmission of the CSI during the MBS multicast DRX active time is allowed based on the configuration information and the CSI mask.

In one embodiment, the configuration information is included in a configuration of medium access control (MAC) parameters for a cell group.

In one embodiment, the SRS includes a periodic SRS or a semi-persistent SRS, and the CSI includes a CSI report on physical uplink control channel (PUCCH) or a semi-persistent CSI on physical uplink shared channel (PUSCH).

In one embodiment, a method performed by a base station in wireless communication includes transmitting, to a user equipment (UE), configuration information indicating whether a transmission of channel state information (CSI) or sounding reference signal (SRS) during multicast and broadcast service (MBS) multicast discontinuous reception (DRX) active time is allowed, and receiving, from the UE, the CSI or the SRS within the MBS multicast DRX active time and outside the unicast DRX active time, in case that the transmission of the CSI or the SRS during the MBS multicast DRX active time is allowed based on the configuration information.

In one embodiment, the CSI or the SRS is not transmitted in case that the transmission of the CSI or the SRS during the MBS multicast DRX active time is not allowed based on the configuration information.

In one embodiment, the method further includes transmitting, to the UE, information for configuring a CSI mask, the CSI is not transmitted in case that the transmission of the CSI during the MBS multicast DRX active time is not allowed based on the configuration information and the CSI mask, and the CSI is transmitted within the MBS multicast DRX active time and outside the unicast DRX active time in case that the transmission of the CSI during the MBS multicast DRX active time is allowed based on the configuration information and the CSI mask.

In one embodiment, the configuration information is included in a configuration of medium access control (MAC) parameters for a cell group.

In one embodiment, the SRS includes a periodic SRS or a semi-persistent SRS, and the CSI includes a CSI report on physical uplink control channel (PUCCH) or a semi-persistent CSI on physical uplink shared channel (PUSCH).

In one embodiment, a user equipment (UE) in a wireless communication includes a transceiver, and at least one processor operatively coupled with the transceiver and configured to receive, from a base station, configuration information indicating whether a transmission of channel state information (CSI) or sounding reference signal (SRS) during multicast and broadcast service (MBS) multicast discontinuous reception (DRX) active time is allowed, and identify whether to transmit the CSI or the SRS within the MBS multicast DRX active time and outside a unicast DRX active time, based on the configuration information, in case that the transmission of the CSI or the SRS during the MBS multicast DRX active time is allowed based on the configuration information, the CSI or the SRS is transmitted within the MBS multicast DRX active time and outside the unicast DRX active time.

In one embodiment, the CSI or the SRS is not transmitted in case that the transmission of the CSI or the SRS during the MBS multicast DRX active time is not allowed based on the configuration information.

In one embodiment, the UE further receives, from the base station, information for configuring a CSI mask, the CSI is not transmitted in case that the transmission of the CSI during the MBS multicast DRX active time is not allowed based on the configuration information and the CSI mask, and the CSI is transmitted within the MBS multicast DRX active time and outside the unicast DRX active time in case that the transmission of the CSI during the MBS multicast DRX active time is allowed based on the configuration information and the CSI mask.

In one embodiment, the configuration information is included in a configuration of medium access control (MAC) parameters for a cell group.

In one embodiment, the SRS includes a periodic SRS or a semi-persistent SRS, and the CSI includes a CSI report on physical uplink control channel (PUCCH) or a semi-persistent CSI on physical uplink shared channel (PUSCH).

In one embodiment, a base station in a wireless communication includes a transceiver, and at least one processor operatively coupled with the transceiver and configured to transmit, to a user equipment (UE), configuration information indicating whether a transmission of channel state information (CSI) or sounding reference signal (SRS) during multicast and broadcast service (MBS) multicast discontinuous reception (DRX) active time is allowed, and receive, from the UE, the CSI or the SRS within the MBS multicast DRX active time and outside the unicast DRX active time, in case that the transmission of the CSI or the SRS during the MBS multicast DRX active time is allowed based on the configuration information.

In one embodiment, the CSI or the SRS is not transmitted in case that the transmission of the CSI or the SRS during the MBS multicast DRX active time is not allowed based on the configuration information.

In one embodiment, the base station further transmits, to the UE, information for configuring a CSI mask, the CSI is not transmitted in case that the transmission of the CSI during the MBS multicast DRX active time is not allowed based on the configuration information and the CSI mask, and the CSI is transmitted within the MBS multicast DRX active time and outside the unicast DRX active time in case that the transmission of the CSI during the MBS multicast DRX active time is allowed based on the configuration information and the CSI mask.

In one embodiment, the configuration information is included in a configuration of medium access control (MAC) parameters for a cell group.

In one embodiment, the SRS includes a periodic SRS or a semi-persistent SRS, and the CSI includes a CSI report on physical uplink control channel (PUCCH) or a semi-persistent CSI on physical uplink shared channel (PUSCH).

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the UE can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a digital signal processor (DSP), an application specific integrated circuit (ASIC), a field programmable gate array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal or the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The foregoing description of the specific embodiments reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

While the disclosure has been particularly shown and described with reference to certain embodiments thereof, it will be understood by those of ordinary skill in the art that various changes in form and details may be made therein without departing from the spirit and scope of the disclosure as defined by the following claims and their equivalents.

What is claimed is:

1. A method performed by a user equipment (UE) in a wireless communication, the method comprising:
receiving, from a base station, configuration information indicating whether a transmission of channel state information (CSI) or sounding reference signal (SRS) during multicast and broadcast service (MBS) multicast discontinuous reception (DRX) active time is allowed; and
identifying whether to transmit the CSI or the SRS within the MBS multicast DRX active time and outside a unicast DRX active time, based on the configuration information,
wherein the CSI or the SRS is transmitted within the MBS multicast DRX active time and outside the unicast DRX active time in case that the transmission of the CSI or the SRS during the MBS multicast DRX active time is allowed based on the configuration information.

2. The method of claim 1,
wherein the CSI or the SRS is not transmitted in case that the transmission of the CSI or the SRS during the MBS multicast DRX active time is not allowed based on the configuration information.

3. The method of claim 2, further comprising:
receiving, from the base station, information for configuring a CSI mask,
wherein the CSI is not transmitted in case that the transmission of the CSI during the MBS multicast DRX active time is not allowed based on the configuration information and the CSI mask, and
wherein the CSI is transmitted within the MBS multicast DRX active time and outside the unicast DRX active time in case that the transmission of the CSI during the MBS multicast DRX active time is allowed based on the configuration information and the CSI mask.

4. The method of claim 1,
wherein the configuration information is included in a configuration of medium access control (MAC) parameters for a cell group.

5. The method of claim 1,
wherein the SRS includes a periodic SRS or a semi-persistent SRS, and
wherein the CSI includes a CSI report on physical uplink control channel (PUCCH) or a semi-persistent CSI on physical uplink shared channel (PUSCH).

6. A method performed by a base station in wireless communication, the method comprising:
transmitting, to a user equipment (UE), configuration information indicating whether a transmission of channel state information (CSI) or sounding reference signal (SRS) during multicast and broadcast service (MBS) multicast discontinuous reception (DRX) active time is allowed; and
receiving, from the UE, the CSI or the SRS within the MBS multicast DRX active time and outside the unicast DRX active time, in case that the transmission of the CSI or the SRS during the MBS multicast DRX active time is allowed based on the configuration information.

7. The method of claim 6,
wherein the CSI or the SRS is not transmitted in case that the transmission of the CSI or the SRS during the MBS multicast DRX active time is not allowed based on the configuration information.

8. The method of claim 7, further comprising:
transmitting, to the UE, information for configuring a CSI mask,
wherein the CSI is not transmitted in case that the transmission of the CSI during the MBS multicast DRX active time is not allowed based on the configuration information and the CSI mask, and
wherein the CSI is transmitted within the MBS multicast DRX active time and outside the unicast DRX active time in case that the transmission of the CSI during the MBS multicast DRX active time is allowed based on the configuration information and the CSI mask.

9. The method of claim 6,
wherein the configuration information is included in a configuration of medium access control (MAC) parameters for a cell group.

10. The method of claim 6,
wherein the SRS includes a periodic SRS or a semi-persistent SRS, and
wherein the CSI includes a CSI report on physical uplink control channel (PUCCH) or a semi-persistent CSI on physical uplink shared channel (PUSCH).

11. A user equipment (UE) in a wireless communication, the UE comprising:
a transceiver, and
at least one processor operatively coupled with the transceiver and configured to:
receive, from a base station, configuration information indicating whether a transmission of channel state information (CSI) or sounding reference signal (SRS) during multicast and broadcast service (MBS) multicast discontinuous reception (DRX) active time is allowed; and
identify whether to transmit the CSI or the SRS within the MBS multicast DRX active time and outside a unicast DRX active time, based on the configuration information,
wherein the CSI or the SRS is transmitted within the MBS multicast DRX active time and outside the unicast DRX active time in case that the transmission of the CSI or the SRS during the MBS multicast DRX active time is allowed based on the configuration information.

12. The UE of claim 11,
wherein the CSI or the SRS is not transmitted in case that the transmission of the CSI or the SRS during the MBS multicast DRX active time is not allowed based on the configuration information.

13. The UE of claim 12, further comprising:
receive, from the base station, information for configuring a CSI mask,
wherein the CSI is not transmitted in case that the transmission of the CSI during the MBS multicast DRX active time is not allowed based on the configuration information and the CSI mask, and
wherein the CSI is transmitted within the MBS multicast DRX active time and outside the unicast DRX active time in case that the transmission of the CSI during the MBS multicast DRX active time is allowed based on the configuration information and the CSI mask.

14. The UE of claim 11,
wherein the configuration information is included in a configuration of medium access control (MAC) parameters for a cell group.

15. The UE of claim 11,
wherein the SRS includes a periodic SRS or a semi-persistent SRS, and
wherein the CSI includes a CSI report on physical uplink control channel (PUCCH) or a semi-persistent CSI on physical uplink shared channel (PUSCH).

16. Abase station in a wireless communication, the base station comprising:
a transceiver, and
at least one processor operatively coupled with the transceiver and configured to:
transmit, to a user equipment (UE), configuration information indicating whether a transmission of channel state information (CSI) or sounding reference signal (SRS) during multicast and broadcast service (MBS) multicast discontinuous reception (DRX) active time is allowed; and
receive, from the UE, the CSI or the SRS within the MBS multicast DRX active time and outside the unicast DRX active time, in case that the transmission of the CSI or the SRS during the MBS multicast DRX active time is allowed based on the configuration information.

17. The base station of claim 16,
wherein the CSI or the SRS is not transmitted in case that the transmission of the CSI or the SRS during the MBS multicast DRX active time is not allowed based on the configuration information.

18. The base station of claim 17, further comprising:
transmit, to the UE, information for configuring a CSI mask,
wherein the CSI is not transmitted in case that the transmission of the CSI during the MBS multicast DRX active time is not allowed based on the configuration information and the CSI mask, and
wherein the CSI is transmitted within the MBS multicast DRX active time and outside the unicast DRX active time in case that the transmission of the CSI during the MBS multicast DRX active time is allowed based on the configuration information and the CSI mask.

19. The base station of claim 16,
wherein the configuration information is included in a configuration of medium access control (MAC) parameters for a cell group.

20. The base station of claim 16,
wherein the SRS includes a periodic SRS or a semi-persistent SRS, and
wherein the CSI includes a CSI report on physical uplink control channel (PUCCH) or a semi-persistent CSI on physical uplink shared channel (PUSCH).
